(19) United States
(12) Patent Application Publication
(10) Pub. No.: US 2025/0217772 A1
(43) Pub. Date: Jul. 3, 2025

(54) INTER-MODEL INTERFACE TO REFINE REMOTE POOL AND USER INTERFACES THEREFOR

(71) Applicant: Wells Fargo Bank, N.A., San Francisco, CA (US)

(72) Inventors: Damu McCoy, San Francisco, CA (US); Shobha Duggirala, San Francisco, CA (US); Jennel A. McDonald, San Francisco, CA (US); Art Lokerson, San Francisco, CA (US)

(73) Assignee: Wells Fargo Bank, N.A., San Francisco, CA (US)

(21) Appl. No.: 18/403,679

(22) Filed: Jan. 3, 2024

(51) Int. Cl. G06Q 10/1053; G06F 40/103; G06F 40/40

(52) U.S. Cl. CPC G06Q 10/1053; G06F 40/103; G06F 40/40

(57) ABSTRACT

Aspects of this technical solution relate to a system. The system includes a memory and one or more processors coupled to the memory. The one or more processors are configured to: generate, by a first artificial intelligence model receiving as an input a first object including a first textual description of an entity, one or more first metrics descriptive of the entity; generate, by a second artificial intelligence model receiving as an input one or more of the first metrics, a second object including a second textual description of the entity and a first metric; identify, by the first artificial intelligence model, one or more third objects each having at least one first property satisfying a first metric; and cause a presentation of a portion of the second object at a first portion and a portion of the third object at a second portion of a user interface.

### TECHNICAL FIELD

The present implementations relate generally to user interfaces, including but not limited to, an inter-model interface to refine a dataset, such as a remote pool, and user interfaces therefor.

### BACKGROUND

Employers face challenges when creating and filling job postings. Specifically, employers expend resources and time by scheduling interviews or meetings based on candidate pools containing applicants who may not be suitable for target positions. Tools which filter candidate pools may overly narrow the candidate pool. Manual processes of creating, filling, and refining job postings cannot achieve sufficient granularity or refine remote candidate pools with as many filters or into as many variable categories given the various time constraints and the volume of data available. Additionally, manual processes for creating job listings have only a limited knowledge of the candidate pool and cannot simultaneously predict the effect of revisions or alterations to both the job posting requirements and candidate qualifications to increase the number of qualified applicants or the percentage chance of filling a position. Improved systems and methods for curating and presenting pertinent datasets are desired.

### SUMMARY

This technical solution relates to at least an inter-model interface allowing handoff between two or more artificial intelligence (AI) circuits to provide tailored data objects based on user inputs, predicted refinements determined from metrics and target characteristics, and insights drawn from iterative analyses of current and historic data between the AI circuits. An object descriptive of an entity (e.g., requirements and pre-requisites for an employment position) is received via a user interface by a first artificial intelligence circuit. The first AI circuit generates first metrics (preferences, proficiencies, qualification) descriptive of a data object (e.g., a job posting). The first AI circuit provides the first metrics to a second AI circuit via the inter-model interface and the second AI circuit generates a second object (e.g., a proposed job posting or listing) to be displayed via a user interface. The AI circuits refine and provide updated metrics, (e.g., job candidates, position perquisites), data objects (e.g., job postings, job descriptions), and associated user interfaces in real-time based on an at least an existing job pool of applicants and applicant data. For example, this technical solution can identify or generate a long-form and descriptive job posting tailored to a target group of applicants based on informal input data such as bullet point lists, employer preferences, and the like received via input from a user interface (e.g., preferences or natural text objects received from an individual, a recruiter, an HR director, and the like).

The systems, methods, and apparatuses described herein provide enable-generating predictions in real time to adjust job posting descriptions, pre-requisites for applicants, desired qualities in applicants, form/format of the job descriptions, among other refinements to develop a predefined job posting format (e.g., a long-form job posting) and visualize likely candidates for employment. Further, the AI circuit and inter-model interface can achieve at least the technical improvement of providing insights and prompts suggesting revisions and granulated refinements of job requirements and candidate pools that allow analysis and fine-tuning of both job postings and candidates beyond the capability of manual processes. For example, a system may receive a brief or informal description of a job posting or employment position via a user interface. The system may determine metrics such as desired educational backgrounds, desired experience levels, desired salary ranges, and the like that accompany the provided informal description. Additionally, the system may utilize the informal description and generated metrics to generate a job posting targeted to potential applicants. Further, the system may analyze a pool of all available applicants and determine the match, overlap, and/or ranking of the applicants corresponding to the generated job description. Also, the system may prioritize distinguishing or estimated features of importance and generate a listing of potential applicants, illustrating qualities such as perceived fit for the job posting. Finally, the system may refine or suggest refining characteristics and alter the job posting and/or applicant pool in real-time based on metrics, qualities, or preferences determined by one or more artificial intelligence circuits. Thus, a technical solution for an inter-model interface to refine a remote pool and user interfaces therefor is provided.

At least one aspect of the present disclosure relates to a system. The system can include a memory and one or more processors. The system can generate, by a first artificial intelligence model receiving as input a first object which can include first text descriptive of an entity, one or more first metrics descriptive of the entity. The system can generate, by a second artificial intelligence model receiving as input one or more of the first metrics, a second object which can include second text descriptive of the entity and one or more of the first metrics. The system can identify, by the first artificial intelligence model receiving as input one or more of the first metrics, one or more third objects each having at least one first property satisfying one or more of the first metrics. The system can cause a user interface to present at least a portion of the second object at a first portion of the user interface. The system can cause the user interface to present at least a portion of one or more of the third objects at a second portion of the user interface at least partially distinct from the first portion of the user interface.

At least one additional aspect of the present disclosure relates to a method. The method can include generating, by a first artificial intelligence model receiving as input a first object which can include first text descriptive of an entity, one or more first metrics descriptive of the entity. The method can include generating, by a second artificial intelligence model receiving as input one or more of the first metrics, a second object which can include second text descriptive of the entity and one or more of the first metrics. The method can include identifying, by the first artificial intelligence model receiving as input one or more of the first metrics, one or more third objects each having at least one first property satisfying one or more of the first metrics. The method can include causing a user interface to present at least a portion of the second object at a first portion of the user interface. The method can include causing the user interface to present at least a portion of one or more of the third objects at a second portion of the user interface at least partially distinct from the first portion of the user interface.

At least one further aspect of the present disclosure relates to a non-transitory computer readable medium that can include one or more instructions stored thereon and executable by at least one processor. The processor can generate, via a first artificial intelligence model receiving as input a first object which can include first text descriptive of an entity, one or more first metrics descriptive of the entity. The processor can generate, via a second artificial intelligence model receiving as input one or more of the first metrics, a second object which can include second text descriptive of the entity and one or more of the first metrics. The processor can identify, via the first artificial intelligence model receiving as input one or more of the first metrics, one or more third objects each having at least one first property satisfying one or more of the first metrics. The processor can cause a user interface to present at least a portion of the second object at a first portion of the user interface. The processor can cause the user interface to present at least a portion of one or more of the third objects at a second portion of the user interface at least partially distinct from the first portion of the user interface.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts a computing system, according to an example embodiment.

FIG. 2 depicts an AI circuit architecture, according to an example embodiment.

FIG. 3 depicts an environment architecture, according to an example embodiment.

FIG. 4A depicts a user interface, according to an example embodiment.

FIG. 4B depicts another user interface including rendered content, according to an example embodiment.

FIG. 5A depicts a refinement user interface, according to an example embodiment.

FIG. 5B depicts a refinement user interface including rendered content, according to an example embodiment.

FIG. 6 depicts a method for providing a real-time applicant dashboard and tool, according to an example embodiment.

FIG. 7 depicts additional steps to the method for providing a real-time applicant dashboard and tool of FIG. 6, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Systems, apparatuses, and methods utilizing an inter-model interface to refine applicant pools and corresponding user interfaces are needed to improve the generation of job postings, the tailoring of criteria for desired candidates, and the predicting of candidate compatibility. The systems, methods, and apparatuses described herein refine applicant pools and user interfaces therefor to provide technical solutions that develop improved job requirements with improved candidate qualification criteria.

This technical solution relates to providing a real-time applicant dashboard and tool configured to generate and revise job postings and view applicable candidates in real-time or nearly real-time. As described herein, a provider computing system can receive, via at least one user input, an object containing information indicative of a job posting, preferential candidate qualifications, employment responsibilities, and the like. The provider computing system can then generate, by a first artificial intelligence model, one or more first metrics. In particular, first metrics include text or metadata descriptive of the job posting that are tailored to fulfil the user's/recruiter's employment need. The provider computing system may also allow the first artificial intelligence model to communicate with a second artificial intelligence model of the provider computing system. For example, the second artificial intelligence model or circuit may receive as an input one or more of the first metrics descriptive of the job posting or employment criteria. The provider computing system may also generate, via the second artificial intelligence circuit, a long-form job posting, or form representative of the metrics and preferences received from the user and processed by the first artificial intelligence circuit. The provider computing system may also identify, by the first artificial intelligence model receiving as input one or more of the first metrics, one or more potential candidates from a candidate pool, each having at least one quality satisfying one or more of the first metrics. The provider computing system may also cause a user interface to present at least a portion of a job description at a first portion of the user interface and cause the user interface to present at least an indication of potential candidates that correspond to the job description at a second portion of the user interface.

In this way, the provider computing system can provide a technical solution for real-time generation, analysis, and refinement of one or more database objects (e.g., job postings, the corresponding potential applicant pool, predicted metrics to expand either the applicant pool or the job pre-requisites, etc.), to achieve a technical improvement in dataset formulations to, for example, at least provide employers with insights on adjustments that may be made to optimize employee recruitment decisions. Specifically, the provider computing system (also referred to as a real-time application (“RAP”) computing system) disclosed herein utilizes predictive and generative feedback from multiple circuits to expand the granularity and customization of job postings and candidate metrics beyond the capability of manual processes. For example, the provider computing system disclosed herein may simultaneously provide predictive insights on adjustments that may be made to tailor a job posting to best fit an applicant pool while also providing predictive insights on adjustments that may be made to tailor an applicant pool to best fit a job posting. These and other features and benefits are described more fully herein below.

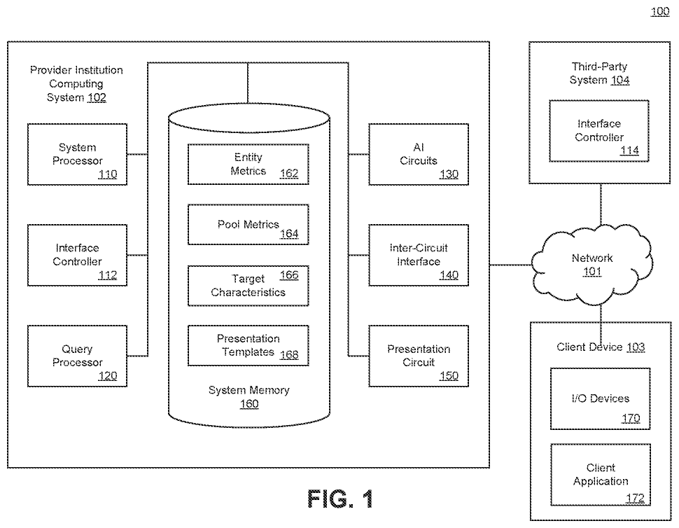

FIG. 1 depicts a block diagram of a Real-Time Applicant Pool (“RAP”) system architecture utilizing an inter-model interface, according to an example embodiment. As illustrated by way of example in FIG. 1, a system 100 can include at least a network 101, a provider institution computing system 102, and a client device 103 having I/O devices 170. The provider institution computing system 102 may receive inputs from a user via the I/O devices 170 (e.g., employment requirements, desired credentials of candidates, etc. from a recruiter). The provider institution computing system 102 may draw from the third-party system 104 one or more data sources such as candidate pools, previously filled job requisitions, and the like to generate job postings and corresponding candidate pools from current or prospective applicants. Further, the provider institution computing system 102 may predict refinements and their corresponding effect on the job description and applicant pool to increase the likelihood of filling a job requisition, optimize the qualifications of the target candidate, and minimize the time required to complete the requisition process.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider institution computing system 102 is owned by, associated with, or otherwise operated by a provider institution (e.g., a bank or other financial institution, an entity having a human resources (HR) department, a business utilizing a human resource information system, an individual seeking to interview or obtain employees, etc.). The provider institution may have a system, employee (e.g., a hiring director, HR lead, recruiter, etc.), individual, or department that maintains one or more devices operable to recruit and hire potential employment candidates (e.g., a recruiting or hiring party). For example, the recruiting or hiring party may be the client associated with the client device 103, such as computer accessing a human resources network, a laptop accessing a job posting site, a terminal or web portal to view potential employees and applicants, and so on. In some instances, the provider institution computing system, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider institution computing system may be or may include various other devices communicably coupled thereto, such as, for example, desktop or laptop computers (e.g., tablet computers), smartphones, wearable devices (e.g., smartwatches), and/or other suitable devices.

The provider institution computing system 102 is shown to include a system processor 110, an interface controller 112, a query processor 120, AI circuits 130, an inter-circuit interface 140, a presentation circuit 150, and a system memory 160.

The system processor 110 can execute one or more instructions associated with the provider institution computing system 102. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The memory may include one or more devices (e.g., RAM, ROM, Flash memory, hard disk storage) for storing data and/or computer code for completing and/or facilitating the various processes described herein. The memory may include non-transient volatile memory, non-volatile memory, and non-transitory computer storage media, database components, object code components, script components, or any other type of information structure for supporting the various activities and information structures described herein. The system processor 110 or the provider institution computing system 102 generally can include one or more communication bus controllers to effect communication between the system processor 110 and the other elements of the provider institution computing system 102.

The interface controller 112 is a controller structured or configured to link the provider institution computing system 102 with one or more of the network 101, the client device 103, and the third-party system 104, by one or more communication interfaces. A communication interface can include, for example, an application programming interface (“API”) compatible with a particular component of the provider institution computing system 102, the client device 103, or the third-party system 104. The communication interface can provide a particular communication protocol compatible with a particular component of the provider institution computing system 102 and a particular component of the client device 103 or the third-party system 104. The interface controller 112 can be compatible with particular content objects and can be compatible with particular content delivery systems corresponding to particular content objects, structures of data, types of data, or any combination thereof. For example, the interface controller 112 can be compatible with transmission of video content, audio content, image data, or any combination thereof. For example, the interface controller 112 can be compatible with a first artificial intelligence model and a second artificial intelligence model to receive as inputs natural text queries/requirements and to send as outputs generated text, audio, or visual postings or descriptions.

The query processor 120 can analyze, parse, inspect, or otherwise process an input/prompt/query received from the client device 103. The query processor 120 can include an electronic processor, an integrated circuit, or the like including one or more of digital logic, analog logic, digital sensors, analog sensors, communication buses, volatile memory, nonvolatile memory, and the like. The query processor 120 can include, but is not limited to, at least one microcontroller unit (MCU), microprocessor unit (MPU), central processing unit (CPU), graphics processing unit (GPU), physics processing unit (PPU), embedded controller (EC), or the like. The query processor 120 may be configured to receive a text input, voice input, image input, video input, or any combination thereof (e.g., query) from the client device 103. For example, the query may include a listing of job qualification requirements, a range of years of experience to designate qualified applicants, a skill level, a degree or indication of education, an occupation location, and so on. The query processor 120 may be configured to tokenize the text input into tokens (e.g., phrases, passages, individual words, sub-words, punctuation, etc.). The query processor 120 may be configured to transform, convert, or otherwise encode each token generated for the text input into an encoded token. The encoded token may be encoded into a format (such as vector format, word embeddings, etc.) that is compatible with the presentation circuit 150 or one or more user interfaces corresponding to the presentation circuit 150, as described in greater detail herein. The query processor 120 may tokenize the query and encode the tokens for applying to one or more neural networks of the AI circuits 130. The query processor 120 can detect a particular structure or format of the input or the query and can generate a query having a particular structure or format, based on the input.

The AI circuits 130 can provide one or more data transformations according to two or more models, where the data transformations are semantically meaningful. Specifically, the two or more models may include at least one machine learning circuit (“ML circuit”) and at least one generative artificial intelligence circuit (“genAI circuit”), which may exchange, handoff, and communicate data between each other and/or other components of the provider institution computing system 102 to facilitate population and use of a Real-Time Applicant dashboard and tool utilizing an inter-model interface. For example, an inter-modal interface includes one or more application programming interfaces (“APIs”) to transform at least part of an output of a machine learning model into a transformed prompt having a format compatible with input to a generative AI model, and to transmit the transformed prompt to the generative AI model. For example, an inter-modal interfaces includes one or more application programming interfaces (“APIs”) to transform at least part of an output of a generative AI model into at least one transformed feature having a format compatible with input to a machine learning model, and to transmit the transformed feature to the machine learning model. For example, the AI circuits 130 may include a neural network (such as a generative pre-trained transformer neural network) trained to generate responses to queries. Additionally, the neural network may be trained using data from, at least, the system memory 160. In this the regard, the neural network(s) may be trained using the standardized, labeled data ingested or otherwise received from the external source(s) and internal source(s). For example, the system memory 160 may include previous employment applications, resumes, current employee data, or human resources information indicative of one or more qualities associated with a job position or posting. For example, the neural network(s) may be trained using the dataset stored in or received from the third-party system(s) 104, such as employment applications submitted by third-parties, recruitment data provided by remote databases, published employment statistics and location data, along with various examples of answers to queries. The neural network(s) may be trained by tokenizing the dataset, initializing the weights and biases of the neural network(s), feeding inputs (e.g., example queries) to the neural network(s), and using a loss function to quantify discrepancies between the response to the queries generated by the neural network(s) and the answer. The neural network(s) may update the weights/biases based on the output/discrepancy until the neural network(s) satisfies various testing/training criteria. At the deployment stage, the neural network(s) may be configured to receive the encoded tokenized query as an input (e.g., to an input layer of the neural network(s)), perform forward propagation of the encoded tokens to the neural network, extract features, perform non-linear transformations, perform contextual understanding, and generate an output.

Further, the AI circuits 130, can include a first artificial intelligence model (shown as the machine learning circuit 210) trained according to a machine learning system, and a second artificial intelligence model (shown as the generative AI circuit 220) trained according to a generative artificial intelligence system. Upon determining a context of the query, the AI circuits 130 may generate one or more prompts or queries to obtain data relevant to the query. The AI circuits 130 may be configured to retrieve or otherwise request data which is relevant to the information which was requested. For example, if the query asks for salary information relating to a particular employment position (e.g., estimated desired salary for a workplace supervisor, average salary for design engineer, etc.), the AI circuits 130, upon determining that the context of the query is salary information relating to a particular or generic employment position, may generate a query to third-party system 104 and/or one or more data source(s) to obtain information/data relating to the employment position or candidates seeking the employment position. The AI circuits 130 may be configured to supply the data as an input to the AI circuits 130 for generating various projections/outlook information relating to the query. In this regard, the AI circuits 130 may be configured to query for real-time or near real-time data as an input, to provide more accurate projections/responses. Further the AI circuits 130 may provide improved projections, candidate pool predictions, refinement prompts, and the like based on feedback between the AI circuits 130 via the inter-model interface (e.g., an inter-circuit interface 140). For example, the AI circuits 130 may simultaneously predict the effect of one or more revisions on an applicant pool, adjust applicant pool sized based on analysis of current applicants, and provide insights tailored to increase the fit between a job posting and a target applicant.

The inter-circuit interface 140 is structured or configured to enable feedback and concurrent communication between the AI circuits 130 (e.g., the ML circuit and the genAI circuit). The inter-circuit interface 140 can generate and modify one or more metrics corresponding to one or more queries, inputs, responses, outputs, user interfaces, devices, profiles, or any combination thereof. For example, the inter-circuit interface 140 can acquire a metric generated by a first artificial intelligence circuit (e.g., the ML circuit) that indicates one or more structures or formats corresponding to one or more queries, responses, user interfaces, or any combination thereof and communicate the metric to a second artificial intelligence model (e.g., the genAI circuit) to produce revised, updated, or new objects representative of at least a portion of the metric. For example, the inter-circuit interface 140 can allow the ML circuit to access a job posting generated by the genAI circuit and update one or more metrics to indicate a targeted change in the job posting. In one embodiment, a job posting applicable to individuals nationwide may be received by the ML circuit from the genAI circuit via the inter-circuit interface 140, the inter-circuit interface 140 may allow the ML circuit to detect the broad scope and update the metrics for the job posting to a select number of states where offices are present, the inter-circuit interface 140 may then provide the updated metric to the genAI circuit to regenerate or update the job posting or candidate pool to reflect the scope limited to specific states). Additionally, the inter-circuit interface 140 can permit the AI circuits 130 to communicate to each other that a particular structure of data corresponds to a particular volume or size of text data, voice data, image data, video data, or any combination thereof.

The presentation circuit 150 can generate, determine, derive, or otherwise provide one or more outputs at least partially corresponding to a response by the output from the AI circuits 130. For example, the presentation circuit 150 can generate or transform a structure of data corresponding to a response to correspond to a particular user interface or a particular characteristic. For example, the presentation circuit 150 can select a user interface corresponding to a structure of data corresponding the user interface and can transmit the response having the particular data structure to one or more user interfaces configured to present the response according to the structure. For example, the presentation circuit 150 can be configured to provide responses in various formats, including for example text outputs, table outputs, visual or graphical outputs, and so forth, or to instruct or cause a user interface to provide responses in various formats. The presentation circuit 150 may be configured to generate the responses at one or more of the client device 103 or the third-party system 104.

The system memory 160 can store data associated with the provider institution computing system 102. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device. The system memory 160 can include an entity metrics 162, pool metrics 164, target characteristics 166, and presentation templates 168.

The entity metrics 162 is a dataset regarding one or more aspects of one or more job postings, job requirements, candidate features, qualifications, position requirements, employer preferences, or the like. For example, the entity metrics 162 can include information regarding specific attributes or characteristics regarding the performance, suitability, or effectiveness of a job posting, employee, prospective employee, etc. Entity metrics 162 may include information regarding retention rates of previous employees based on information in the system memory 160 or received from the third-party system 104. Entity metrics 162 may also include information regarding job titles, salary arrangements, education requirements, certification requirements, location availability, scope of available benefits, employee responsibilities, department designations, and so on. Further, the data or information within the entity metrics 162 may be tiered, ranked, or placed in a hierarchy based on a classification of the job posting, the number of potential applicants sought, an availability of funds, or by another criteria.

The entity metrics 162 may be generated by one or more of the AI circuits 130. For example, the ML circuit may receive inputs, queries, job descriptions or the like from a recruiter via the client device 103. The ML circuit may then generate, access, store, revise, or update detect entity metrics 162 based on the received data from the client device 103. In some respects, entity metrics 162 may include descriptions from prior job postings, anticipated changes in job requirements based on predefined or predicted events (e.g., additional responsibilities of a role in anticipation of acquiring new assets, alterations to descriptions based on variations in skill level from one position to another). Entity metrics 162 may include or correspond to information regarding descriptive metrics which define or classify a user's preferences regarding a job description, candidate qualifications, and the like. Entity metrics 162 may also include or correspond to information regarding target metrics that allow for a weighted analysis of qualifications, preferences, candidate criteria, and the like based on the estimated or indicated importance of that data relative to other data contained within a job post or listing.

The pool metrics 164 is a dataset regarding one or more aspects of one or more job candidates, potential employees, applicants, resumes, applicant profiles, employment submissions/inquiries, employee histories, skills attributable to a population or class of applicants, qualifications that may increase or decrease the number of potential job candidates, or the like. The provider institution computing system 102 may utilize pool metrics 164 information as measurements or indicators to assess and/or evaluate a pool of past, present, or potential employee candidates. For example, the pool metrics 164 can include information regarding pre-screened applicant information, key words in application materials, applicant profile images, or locations. The pool metrics 164 may also include information regarding predictive qualities that increase or decrease the size of an applicant pool or adjust the weight/importance given to descriptive text or objects received via the user interface. For example, the pool metrics 164 may include information regarding flexible experience or educational requirements that vary based on a number of applicants present in a pool, the complexity of an employment position, etc. The pool metrics 164 may also include other meaningful data for HR and recruitment such as the time-to-fill of a position.

The target characteristics 166 is a dataset regarding one or more aspects of one or more structures of data or formats of data. For example, the target characteristics 166 may include information regarding a type of data, a number of rows, columns, objects, or any combination thereof, or links or relationships among portions of the data. The target characteristics 166 may also include information regarding one or more problem solving strategies, pattern association algorithms, sampling strategies, or the like to generate predictions regarding which candidates closely fit to a particular job posting, which metrics may be included or excluded to expand or alter the predicted candidate pool, likely keywords to include in a candidate refinement search, etc. For example, a structure of data can correspond to a graph, a container of objects, a waveform, or a bit stream. For example, a format of data can correspond to an order or composition of the data that indicates a type of the data. For example, a format can correspond to a type of image, video, audio, virtual environment object, or any combination thereof. The target characteristics 166 may also include information regarding quantified strategies or rules to identify and select candidates who are most likely to fit a particular job or organizational culture.

The target characteristics 166 can further include information regarding one or more aspects of one or more job postings, employer preferences, or potential candidates. For example, the target characteristics 166 can include information regarding a correspondence between one or more relevant candidate backgrounds and applicability to a generated job posting, and one or more structures of data or formats of data compatible with a generated job posting. The target characteristics 166 can include keyword matching, experience matching, education and qualification comparisons, predictions on cultural fit and retention rate, estimations of communication or productivity, and the like. The target characteristics 166 can include information regarding a ranking that indicates an order of selection of a particular candidate, job qualification, or employer preference. For example, the target characteristics 166 can including information regarding a job posting seeking applicants in a certain area (e.g., Florida). The provider institution computing system 102 may vary or adjust the target characteristics 166 information based on a stage of the application process (e.g., accepting applications, interviewing candidates, call-back interviews, etc.) and/or qualities of the application process (e.g., the number of applicants in the pool, the urgency of filling an employment position, etc.).

The presentation templates 168 is a dataset used to provide data to a user interface (e.g., the I/O devices 170) according to a presentation format compatible with the user interface and the data. For example, the presentation templates 168 can include instructions to embed particular text or media objects in particular virtual objects or at predetermined positions in the virtual environment, or to deliver images, audio, or video to a mobile device at particular positions in the user interface. For example, the presentation templates 168 can control a position or an object in a user interface where particular data or a portion of particular data is presented, according to a response. The presentation templates 168 may include pre-generated or real-time generated job postings, user interfaces that display pending employee positions adjacent to corresponding potential applicants, graphs/charts/visuals that condense information or allow information to be expanded upon request, and so on.

The client device 130 is owned, operated, controlled, managed, and/or otherwise associated with a recruiter or manager (e.g., a recruiter or manager of the provider institution). In some embodiments, the client device 130 may be or may comprise, for example, a desktop or laptop computer (e.g., a tablet computer), a smartphone, a wearable device (e.g., a smartwatch), a personal digital assistant, and/or any other suitable computing device. In the example shown, the client device 130 is structured as a mobile computing device, namely a smartphone. The client device 130 can communicate with the provider institution computing system 102 by the network 101 via one or more communication protocols therebetween.

The client device 103 can include a display device. The display device can display at least one or more user interfaces and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. For example, the client device 130 can be or include a device operated by an employer, an HR department, a recruiter, etc. While only one client device 103 is depicted, it is to be appreciated that a plurality of computing devices accessible by one or more separate HR departments, recruiters, individuals, entities, or the like may be included with the provider institution computing system 102.

Additionally, the client device 103 includes one or more I/O devices 170, a network interface circuit, and one or more client applications. While the term “I/O” is used, it should be understood that the I/O devices may be input-only devices, output-only devices, and/or a combination of input and output devices. In some instances, the I/O devices include various devices that provide perceptible outputs (such as display devices with display screens and/or light sources for visually perceptible elements, an audio speaker for audible elements, and haptics or vibration devices for perceptible signaling via touch, etc.), that capture ambient sights and sounds (such as digital cameras, microphones, etc.), and/or that allow the recruiter or manager to provide inputs (such as a touchscreen display, stylus, keyboard, force sensor for sensing pressure on a display screen,

The I/O devices 170 can include a display configured to present a user interface or graphical user interface. The I/O devices 170 can include a user interface presentable on a display device operatively coupled with or integrated with the client device 103. The I/O devices 170 can output at least one or more user interface presentations and control affordances. The I/O devices 170 can generate any physical phenomena detectable by human senses, including, but not limited to, one or more visual outputs, audio outputs, haptic outputs, or any combination thereof.

In the example shown, the client device 103 includes a provider institution client application 172. The provider institution client application 172 may be provided by and at least partly supported by the provider institution computing system 102. In this regard, the client application 172 may be coupled to the provider institution computing system 102 may enable the recruiters or managers to perform various recruiting activities (e.g., account management, application tracking, etc.) and/or perform various transactions (e.g., talent pool modification, candidate reach outs, etc.). In the example shown, the provider institution client application 172 may be a candidate tracking application that enables various recruiting functionalities provided and supported by the provider institution computing system 102. In some instances, the client application 172 provided by the provider institution computing system 102 may additionally be coupled to the network 101 (e.g., via one or more application programming interfaces (APIs), webhooks, and/or software development kits (SDKs)) to integrate one or more features or services provided by the third-party system 104. In some instances, the client application 172 may be provided as a web-based feature or application.

The third-party system 104 can include a computing system associated with a third-party from the user and the provider, and distinct from the provider institution computing system and the client device 103. For example, the third-party system 104 can correspond to a cloud system, a server, a distributed remote system, or any combination thereof. For example, the third-party system 104 can include an operating system to execute a virtual environment. The operating system can include hardware control instructions and program execution instructions. The operating system can include a high-level operating system, a server operating system, an embedded operating system, or a boot loader. The third-party system 104 can include an interface controller 114. The interface controller 114 can correspond at least partially to one or more of structure and operation to the I/O devices 170 and can be distinct from the I/O devices 170.

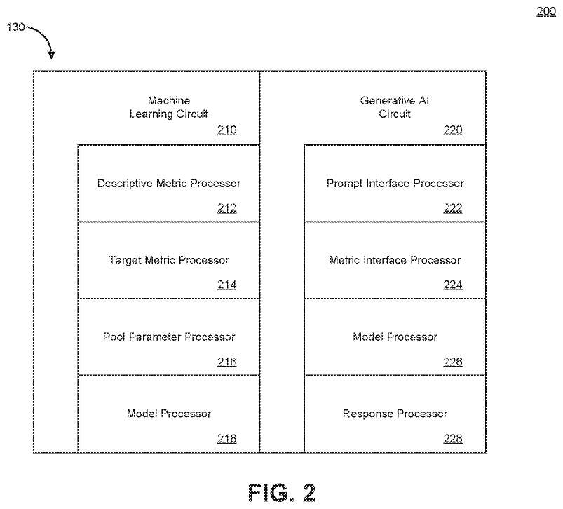

FIG. 2 depicts an example AI circuit architecture according to some embodiments this disclosure. As illustrated by way of example in FIG. 2, an AI circuit architecture 200 can include at least a machine learning circuit 210 (e.g., an ML circuit) and a generative AI circuit 220 (e.g., a genAI). The AI circuit architecture may include one or more AI circuits or models which receive input via the user interface, generate metrics tailored to job postings representative of the inputs received, and create data-driven insights and prompts to refine and adjust job postings and applicant pools based on feedback and iterative communication between the two or more AI circuits.

The machine learning circuit 210 can interpret the data stored in system memory 160 and/or received from the client device 103 and/or third-party system 104. For example, the machine learning circuit 210 may receive descriptions or job posting requirements from a user of a client device 103 and make predictions and/or decisions about the content, format, and requirements of corresponding job postings and potential candidates. The machine learning circuit 210 can include a descriptive metric processor 212, a target metric processor 214, a pool parameter processor 216, and a model processor 218.

The descriptive metric processor 212 is a processor or processing circuit configured or structured to parse the inputs (e.g., data, queries, strings of text, job descriptors, etc.) received from a user of the provider institution computing system 102 (e.g., a recruiter, an HR department, an entity, and the like) and determine/receive corresponding descriptive metrics representative of a job posting or potential candidates. In this way, the descriptive metric processor 212 may convert text, images, resumes, lists, keywords, and the like into descriptive metrics such as job skills, experience levels, education, characteristics indicating cultural fit, etc. that allow for further development of the job posting. For example, a recruiter may input a bullet point list of generic criteria for a job position (e.g., a mechanical engineering position). The recruiter may provide a bullet point list (e.g., pipeline repair, travel to offshore location, experience in drilling industry), a set of keywords (e.g., mechanical, experienced, licensed), an example resume, and the like which may be received and parsed by the descriptive metric processor 212 of the machine learning circuit 210. The descriptive metric processor 212 may compare, correlate, or correspond inputs from the user with data in the system memory 160 (e.g., entity metrics 162). For example, the user may input a string of text including words such as “mechanical engineer, entry level, one to three years of experience preferred, HVAC.” The descriptive metric processor 212 may then process the input and pull corresponding entity metrics 162 that may match, correlate, to, or satisfy the recruiter/user's preferences for the job posting. For example, the descriptive metric processor 212 may indicate or receive data indicative of a salary range, a location, an experience level, a job title, a job description, a preferred personality, a preferred skillset, preferred known languages or technical proficiencies, and the like.

The target metric processor 214 is a processor or processing circuit configured or structured to receive inputs received from a user of the provider institution computing system 102 and detect, correlate, or determine target metrics such as additional qualifiers or descriptors of a job posting or potential candidate that are of particular importance. For example, the target metric processor 214 may assign weights, values indicating importance of respective features (e.g., ranking, percentage values, etc.), to certain descriptive metrics, entity metrics 162, etc. The target metric processor 214 may select a series of tags, categories, filters, or ranges that allow a user to give one job preference or qualification more weight in the application process than others. For example, for a mechanical engineering posting, the target metric processor may provide filters, weights, or flags based on the tier of degree received by potential applicants or included in the job listing (e.g., Bachelor of Science in Mechanical Engineering, Master of Science in Mechanical Engineering, etc.). The target metric processor 214 may also correlate keywords from the input data or query and emphasize other features that allow a user to narrow or target a job posting or applicant pool to a particular subset of applicants. For example, the target metric processor may correlate metrics corresponding to cities, locations (e.g., offshore pipelines), and the like the suggest target locations or regions to list the job posting. In other aspects, the target metric processor 214 may indicate features that increase the appeal or responsiveness of potential applicants to the position (e.g., capacity for remote work, flexible billable hour requirements, maternity/paternity leave, and the like). In other aspects, the target metric processor 214 may flag or indicate features of candidate profiles, applicant resumes, or employee data that may be of particular interest to the recruiter/user of the provider institution computing system 102. For example, an input indicating high salary and five to ten years of experience as requirements may provide target metrics seeking extensive employment history or tenure in a relevant field or industry, a quantity of published material in a related field, etc.

The pool parameter processor 216 is a processor or processing circuit configured or structured to collect and analyze data corresponding to or indicative of past, present, and/or potential candidates, job applicants, and the like and provide the extracted as pool parameters for sorting, refining, or generating an applicant pool. For example, the pool parameter processor 216 may access various available data related to candidates in a pool or database (e.g., the system memory 160, the third-party system 104, etc.) to identify aspects of those candidates that may correspond to the inputs, entity metrics 162, and the like. For example, the pool parameter processor 216 may extract candidate skills, historic employee data (e.g., years of experience of current employees, accreditations of current employees, CLE credentials acquired by current/former employees, etc.), or other relevant attributes and/or qualifications from the pool of applicants available for a job posting or position. The pool parameter processor 216 may also rank all candidates or identify a sub-group of candidates that best match the user/recruiter's likely preferences, descriptive metrics, target metrics, entity metrics 162, and the like. The provider institution computing system 102 may store, access, generate, or update such data from the pool metrics 164 in the system memory 160. Further, the pool parameter processor 216 may perform a pre-processing analysis of candidates by evaluating how well (e.g., based on a percentage match, based on a keywork comparison, based on an algorithm or skillset estimation, etc.) candidates match the user's preferences. The pool parameter processor 216 may analyze, update, and manage information relating to the pool of potential candidates and provide this information to the model processor 218.

The model processor 218 is a processor or processing circuit configured or structured to serve as the core of the machine learning circuit 210. Specifically, the model processor 218 may receive the relevant data, metrics, and/or information processed from the descriptive metric processor 212, target metric processor 214, and the pool parameter processor 216. The descriptive metric processor 212 may communicate or provide descriptive metrics to the model processor 218. For example, the descriptive metric processor 212 may parse user input to receive a set of foundational criteria, key attributes, or qualifications by which to evaluate potential candidates and provide the same to the model processor 218. The model processor 218 utilizes the data from the descriptive metric processor 212, at least in part, to determine the qualifications, attributes, skillsets, and the like desirable for a job listing based on input received indicative of one or more job requirements, candidate qualifications, etc.

The model processor 218 may communicate with the target metric processor 214 and receive weighted metrics, priority flags, preferential skills, and the like to apply and/or consider when evaluating candidates or building a relevant candidate pool or search query. In this way, the model processor 218 may determine which aspects of a candidate, resume, employee profile identified by the descriptive metric processor 212 are the most important to emphasize, retrieve, or prioritize during evaluation or formation of the candidate pool. For example, the model processor 218 may establish a hierarchy, score value, weighted value, or other relational comparison between the descriptive metrics provided by the descriptive metric processor 212 in view of the target metrics provided by the target metric processor 214. In one embodiment, the descriptive metric processor 212 may indicate skills in hard sciences, previous employment in a related industry, ability to speak Portuguese, and ability to relocate or travel as attributes or qualifications desirable for a job posting or position. The model processor 218 may apply the target metrics to diminish the importance of the ability to relocate or travel based on a keyword or indication that remote work is available. Similarly, the model processor may provide greater weight or a higher score to greater years of experience in a related industry based on the complexity of the position or the risks and responsibilities of employment.

The model processor 218 may also communicate and receive data from the pool parameter processor 216. For example, the model processor 218 may receive pool parameters indicative of the available applicants in a candidate pool such as applicant experience, skillsets, backgrounds, indicia of cultural fit (e.g., indications of workplace complaints, analyzed tone of resumes and applications, etc.). The model processor 218 may utilize an algorithm, regression model, classification model, or other method to analyze correlations and relationships between the descriptive metrics, target metrics, and pool parameters to assess each candidate's suitability for a job role based on the user's/recruiter's input and/or preferences. In this way, the model processor 218 may match each candidate to one or more job postings, provide a “percent fit” value for candidates to a particular job posting, or provide other determinations indicating how well each candidate or prospective candidate overlaps with the user's/recruiter's preferences and/or the qualifications for employment of a given position. Further, the model processor 218 may provide a ranked list of applicants, a structured set of attributes needed in a candidate, a tiered or weighted scale of qualifications and experiences preferential for a job posting, a style or tone of a job description to attract candidates with a specific cultural fit, and the like. The model processor 218 may also communicate and exchange this and other data with the generative AI circuit 220.

The generative AI circuit 220 is a processor or processing circuit configured or structured to communicate and receive inputs, structured data, and/or other values from the machine learning circuit 210 to create refined, long-form job postings that may be published, displayed, or otherwise utilized and presented to attract applicants for a job posting. For example, the generative AI circuit 220 may provide a grammatically correct, formatted (e.g., according to a presentation template 168), and descriptive natural text/semantic job description that includes features such as a job title, detailed job description, preferred skills, required skills, location details, benefits package details, and the like. The generative AI circuit 220 may also consider inputs from the machine learning circuit 210 such as qualifiers indicative of cultural fit to construct job posting including a specific tone, specific language decisions (e.g., technical language for hard science positions, casual language for relaxed workplaces, etc.), image and graphic color/tone decisions, and the like. The generative AI circuit 220 can include a prompt interface processor 222, a metric interface processor 224, a model processor 226, and a response processor 228.

The prompt interface processor 222 can receive or parse data received from the machine learning circuit 210 (e.g., in the form of a prompt). The prompt interface processor 222 can receive and modify one or more queries based on one or more criteria. For example, the prompt interface processor 222 can modify a structure of data corresponding to a query to correspond to a model according to the model processor 226. For example, the prompt interface processor 222 can receive a text input and modify a natural language portion of the text input to correspond to a generative artificial intelligence model. In some respects, the prompt interface processor 222 can receive inputs such as job qualifications, weighed or ranked employer preferences, and other instructions and context needed to generate a job posting and/or data relevant to a job posting for a user/recruiter. In other examples, the prompt interface processor 222 can receive an audio input and modify a waveform of the audio input to correspond to a speech-to-text model. In further examples, the prompt interface processor 222 can receive an image input (e.g., a sample resume, a structured list, and the like) and modify a resolution or feature of the image input to correspond to a generative artificial intelligence model.

The metric interface processor 224 can receive and generate labels, buttons to be selected for filtering criteria, or other quantitative and qualitative metrics related to the job posting or information relevant to the job posting. For example, the metric interface processor 224 may include parameters or instructions regarding the tone, preferred template, color palate, use of technical language, use of images, or other preferential characteristics, formal, or structural requirements of the job posting.

Like the model processor 218 of the machine learning circuit 210, the model processor 226 of the generative AI circuit 220 is a processor or processing circuit configured or structured to serve as a core of the generative AI circuit 220. The model processor 226 of the generative AI circuit 220 receives inputs from the prompt interface processor 222 and the metric interface processor 224. By receiving inputs for one or more of the prompt interface processor 222 and the metric interface processor 224, the model processor 226 can generate a semantic text object (e.g., a natural language/English output) according to a generative AI model. The model processor 226 may also generate image data, visuals, graphs, comparisons, charts, and other objects indicative of the job posting, a candidate's qualifications, and the like. The model processor 226 tokenizes the inputs from the prompt interface processor 222 and the metric interface processor 224, applies attention weights, and generates a sequence of tokens representing the job posting, portions of the job portion, or data relevant to the job posting to be used for internal hiring and informative purposes (e.g., internal notes on regarding statistics of the candidate pool for use by an HR department). The model processor 226 may predict the next token at each step, resulting in a coherent and contextually appropriate long-form job posting.

Additionally, the model processor 226 may generate a job posting or portions of a job posting curated for particular job candidates, targeted to improve visibility on search circuits, and/or consistent with successful past job postings or job posting corresponding to those in the system memory 160. The model processor 226 may also generate a list of candidates with selected, emphasized, or targeted portions of their application, resumes, biographical information and the like readily visible or selectively displayed. Further, the model processor 226 may communicate to and receive data from the machine learning circuit 210 such as percentages that a candidate matches as job posting, and the model processor 226 may be configured to display estimated percentages, indicators of fitness for the job positing, and the like adjacent to or corresponding to a list of potential applicants from the pool of applicants.

The response processor 228 is a processor or processing circuit configured or structured to refine and apply additional formatting to the job posting and/or the applicant listing generated by the model processor 226. For example, a job posting is a text object that includes one or more text fragments (e.g., words or phrases) that correspond to one or more criteria or descriptions of a professional role (e.g., a job). The response processor 228 may apply post-generation tasks like grammar checking, formatting, and organizing the content of the job posting and/or candidate listing according to any specified requirements, presentation templates 168, or the like. Additionally, the response processor may generate notations and commentary regarding the applicant pool, recommendations regarding the job posting, and other internal data to be displayed alongside the job posting and candidate listing. For example, such notations, commentary, and data may include statistical assessments regarding shared qualifications of the applicants, sentiment analysis, or keyword optimization recommendations directed to enhancing the quality and effectiveness of the job posting.

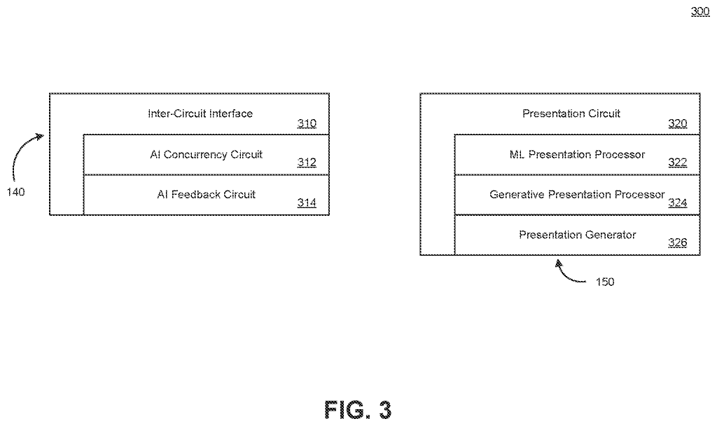

FIG. 3 depicts an example environment architecture according to some embodiments this disclosure. As illustrated by way of example in FIG. 3, an environment architecture 300 can include at least an inter-circuit interface 310, and a presentation circuit 320. The environment architecture may include a structured framework facilitating communication and interaction between the AI circuits 130, the I/O devices 170, and the like. For example, the environment architecture includes an inter-model interface (e.g., the inter-circuit interface 310) which serves as the bridge between the AI circuits 130, facilitating input, processing, and output of information and shared learning between the AI circuits 130. The environment architecture may also allow for natural language processing or other input modalities to understand and act upon data received via the I/O devices 170.

The inter-circuit interface 310 can facilitate communication, collaboration, and other interaction between the machine learning circuit 210 and the generative AI circuit 220. For example, the inter-circuit interface may permit the machine learning circuit 210 to provide suggestions, revised job posting criteria, and the like to the generative AI circuit 220 that may be received and used to generate predictive results or suggested job posting qualifications or attributes. One non-limiting example of such communication or interaction may include the following. The machine learning circuit 220 may determine that a generated applicant pool of a predefined number of applicants (e.g., 200,000 applicants) exceeds a predefined threshold for a position, such as a mechanical engineering intern position. The machine learning circuit 220 may determine that requiring in-person rather than remote work and previous intern experience may narrow the applicant pool. The machine learning circuit 220 may provide these updated job posting qualifications to the generative AI circuit 220 via the inter-circuit interface 310. The generative AI circuit 220 may then generate a hypothetical narrowed applicant pool and an output/selection option suggesting that the recruiter/user refine the pool using one or more tags or filters such as those identified by the machine learning circuit 210.

The inter-circuit interface 310 can include an AI concurrency circuit 312, and an AI feedback circuit 314. The AI concurrency circuit 312 can allow the machine learning circuit 210 and the generative AI circuit 220 to complete tasks and analyze/access candidate data, data in the system memory 160, and the like in parallel. For example, the machine learning circuit 210 may determine descriptive metrics, target metrics, and/or pool parameters from user input data (e.g., text data, informal bullet list inputs, etc.) while simultaneously the generative AI circuit 220 may receive prompts, corresponding metrics, and generate and refine a long-form job posting. Additionally, the machine learning circuit 220 may process and analyze candidate data, user inputs, and the like separate and apart from an action of the generative AI circuit 220 (e.g., generating job postings) and vice versa. In other aspects, the machine learning circuit 210 and the generative AI circuit 220 may concurrency train their respective models on a candidate pool, generated descriptions, data in the system memory 160, etc. By enabling the machine learning circuit 210 and the generative AI circuit 220 to operate and access/interact/edit data in parallel, the AI concurrency circuit 312 may improves the speed of the provider institution computing system 102 in responding to particular user input.

The AI feedback circuit 314 allows the machine learning circuit 210 and the generative AI circuit 220 to iteratively learn from each other's output (e.g., job posting predictions, preferential candidate selections, suggestions regarding narrowing or expanding the applicant pool, etc.). The AI feedback circuit 314 can provide handoff between the machine learning circuit 210 and the generative AI circuit 220. For example, the generative AI circuit 220 may generate a job posting for display on a user interface in addition to a corresponding applicant pool based on initial results or prompts generated by the machine learning circuit 210. For example, the machine learning circuit 210 may develop and/or determine criteria to refine a generated pool of candidates and/or update a job posting to better match a given applicant pool. The machine learning circuit 210 may generate a prompt to develop flags, buttons, filters, or the like and provide the same to the generative AI model 220 in real time. The generative AI model 220 may then update the interface to display the options for refining the candidate pool. Further, once a refining characteristic is selected by a user (e.g., a recruiter selects applicants that prefer remote work), the machine learning circuit 210 may provide updated metrics (e.g., descriptive metrics, target metrics, pool parameters, etc.) to the generative AI circuit 220 to update or alter the long-form job description or posting. In this way, AI feedback circuit 314 allows the user/recruiter to interact with the provider institution computing system 102 in real-time to narrow, filter, adjust, and/or revise the job posting, job description, applicant pool, preferred qualifications, etc.

The presentation circuit 320 can correspond at least partially in one or more of structure and operation to presentation circuit 150. The presentation circuit 320 can include a ML presentation processor 322, a generative presentation processor 324, and a presentation generator circuit 326. The presentation circuit 320 may include a rendering circuit that generates output to display via a user interface. The presentation circuit may formalize generated content into a format for viewing by a user such as a recruiter.

The ML presentation processor 322 is structured or configured to generate graphics, text, one or more portions of a UI, or other elements from the machine learning circuit 210. For example, the ML presentation processor 322 may include a rendering circuit dedicated to processing inputs received from the machine learning circuit 210 and formatting the data as outputs in a structure receivable by the generative AI circuit 220 and/or the I/O devices 170. The ML presentation processor 322 may also generate or render visuals, graphics, or data structures associated with the machine learning circuit 210 such as a candidate or candidates identified in a search that fit some or all of a recruiter's preferences or criteria.

Similarly, the generative presentation processor 324 can render graphics, text, one or more portions of a UI, or other elements from the generative AI circuit 220. For example, the generative presentation processor 324 may include a rendering circuit dedicated to processing inputs received from the generative AI circuit 220 and formatting the data as outputs (e.g., long-form job postings, candidate pool lists, graphs of data regarding the candidate pool, etc.) in a structure receivable by the generative AI circuit 220 and/or the I/O devices 170.

The presentation generator circuit 326 is structured or configured to create and/or render one or more outputs corresponding to the response in accordance with one or more formats and UI characteristics. For example, the presentation generator 236 can generate or cause a user interface to generate an output corresponding to one or more metrics identified by the machine learning circuit 210 and a job posting graphic, text, or layout generated by the generative AI circuit 220.

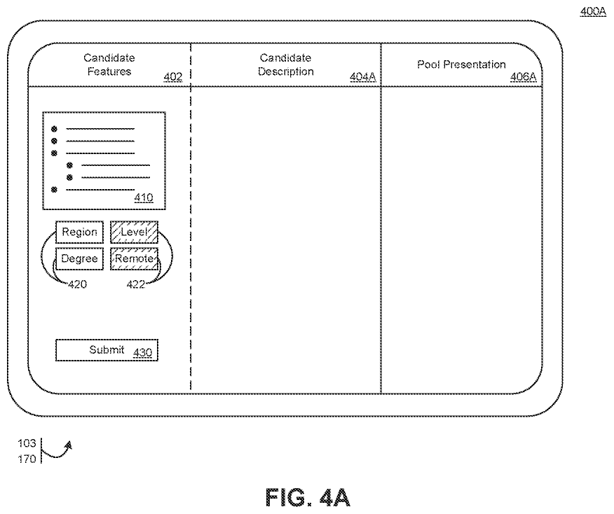

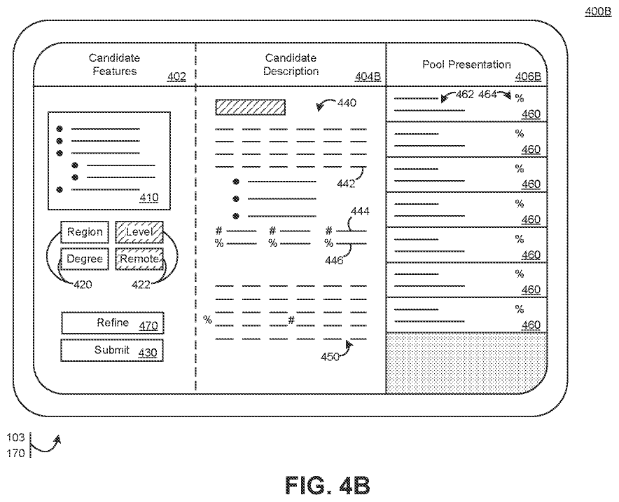

FIG. 4A depicts an example user interface according to some embodiments of the instant disclosure. As illustrated by way of example in FIG. 4A, a user interface 400A can include at least a candidate features presentation feature 402, a candidate description presentation 404A feature, and a pool presentation 406A feature. The user interface may be presented via a display on a desktop or laptop computer (e.g., tablet computer), smartphones, wearable devices (e.g., smartwatches), and/or other suitable devices. The user interface 400A may also be presented or generated by the client application 172, or a part of an application, software, or service associated with the Real-Time Applicant Pool dashboard and tool utilizing an inter-model interface. For example, the user interface may present a dashboard, slide, workspace, job requisition tracker, menus, buttons, lists, charts, and the like. The user interface may also present one or more portals (e.g., one or more toggleable or navigable displays such as a display depicting a draft job description, a display illustrating an exemplary candidate pool, a display indicating weighted qualifications and job pre-requisites, a display indicating a market/applicant pool analysis, or the like). The user interface may also present one or more input fields such as single-line or multi-line text boxes, password fields, dropdown menus, checkboxes, radio buttons, etc.

The candidate features presentation 402 can receive inputs from a user/recruiter (e.g., via the client application 172 of the client device 103) indicative of job preferences, candidate requirements, employee responsibilities, and other target features or aspects to include in a job posting or to seek out in potential job candidates. The candidate features presentation 402 may be generated by one or more components of the presentation circuit 320. The candidate features presentation 402 may also be displayed on one or more user interfaces and allow a user/recruiter to analyze, input, format, adjust, or otherwise interact with a job posting and/or candidate pool in real time. The candidate features presentation 402 can include a candidate outline content feature 410, an unselected affordances feature 420, and a selected affordances feature 422.

The candidate outline content feature 410 can include a first object including a first text descriptive of an entity. In particular, the first object is a formatted or unformatted text string that is descriptive of a role. In this example, the candidate outline content 410 is the first object. For example, the candidate outline content 410 may be received as a string of text listing desired features in a job candidate or responsibilities/requirements of a target employment position. In one embodiment, a user/recruiter may input a bullet point list descriptive of a job position as shown in FIG. 4A. For example, a user may provide input to a user interface via a keyboard, speed-to-text functionality, images, example resumes, or other inputs to designate desirable features to include in a long-form job posting. For example, a recruiter may input strings of text such as “entry level content creator,” “good communication skills,” “remote work position,” “one to two years of professional writing experience required,” “responsibilities include publishing articles, predicting generating graphic design content, writing review,” and the like. The candidate outline content 410 may be received by the machine learning circuit 210 which may begin determining or generating one or more first metrics descriptive of the entity. For example, considering the string of text above, the machine learning circuit 210 may generate or identify descriptive metrics such as background experience of candidates, types of degrees applicable to the position, prior job history from which to source candidates, salary range considering position type, etc. The machine learning circuit 210 may also generate, identify, or suggest target parameters to further refine or prompt additional input data from the user/recruiter.

The unselected affordances feature 420 can indicate target parameters or metrics that may be predicted or predefined in the provider institution computing system 102. The affordances (e.g., selected, unselected) allow the provider institution computing system 102 to utilize at least one input received via a user interface and select, change, or filter certain aspects of a job posting or candidate pool based on characteristics or estimations of the machine learning circuit 210. For example, unselected affordances 420 may include a region limitation on the job posting or a degree requirement on a job posting as shown in FIG. 4A. The provider institution computing system 102 may predict (e.g., via the machine learning circuit 210) or suggest target parameters or unselected affordances 420 based on the information entered by the user recruiter in the candidate outline content 410. For example, the provider institution computing system 102 may unselect a region requirement after detecting that a job posting is a remote work position. Additionally, the provider institution computing system 102 may predict that useful or target information for a job posting is missing and provide an indication of an unselected affordance 420 to prompt a user to input additional data. For example, in the text above, no degree or education requirement is specified. The provider institution computing system 102 may analyze or search the system memory 160, the third-party system 104, or other sources to determine that job postings corresponding to the candidate outline content 410 generally include the unincluded data (e.g., the provider institution computing system 102 may search, inspect, analyze other content creator employment positions, determine that a plurality or majority include a bachelor of arts or literature degree, and cause the I/O devices 170 to display an unselected affordance indicative of the suggested refinement data).

The selected affordances feature 422 highlights or indicates user interface elements that describe or identify target metrics or parameters that may be predicted or predefined in the provider institution computing system 102. For example, selected affordances 422 may automatically populate the candidate outline content 410 with data (e.g., text information, keywords, template, or application designators, etc.). As shown in FIG. 4A, selected affordances may include a skill level associated with the employment position, a remote work option, or other requirements and preferences associated with a target job posting. For example, selecting the a “remote” affordance may populate the candidate outline content 410 with pre-defined or generated text such as “remote work available.” This text may then be utilized by the provider institution computing system 102 to form or generate one or more descriptive or target metrics to generate a long-form job posting.

The candidate description presentation feature 404A can include a first portion of the I/O devices 170. For example, a table, section, window, or other widget associated with the provider institution computing system 102 may be designated to display a preview or current draft of a job posting. As shown in FIG. 4A, the candidate description presentation 404A may initially be blank or include no data prior to the provider institution computing system 102 receiving data indicative of a target job posting (e.g., submission of the candidate outline content 410). For example, the candidate description presentation 404A may remain unoccupied until a user has provided or generated candidate outline content 410 and an input is received via a trigger 430 (e.g., a submission button, a “run” or “generate” button, etc.). In other embodiments, the provider institution computing system 102 may populate the candidate description presentation 404A in real-time as data is received avia the candidate features presentation 402 and/or the candidate outline content 410.

The pool presentation feature 406A can include a second portion of the user interface at least partially distinct from the first portion of the user interface. For example, the pool presentation feature 406A may include a portion, graph, row, section, window, or other widget associated with the provider institution computing system 102 designated to display information indicative of one or more potential candidates that may qualify for the job posting. As shown in FIG. 4A, the pool presentation feature 406A may be located adjacent to the candidate description presentation 404A such that data indicative of a current draft of a job posting may be in line with matching candidates. Further, the pool presentation 406A may be organized in a hierarchical or tiered manner, placing candidates with a higher score, percent match, or likelihood of success to propagate in an area of the user interface that is most visible.

FIG. 4B depicts an example user interface including rendered content according to some embodiments. As illustrated by way of example in FIG. 4B, a user interface including rendered content 400B can include at least a candidate description 404B, a candidate profile content 440, an annotation object 450, candidate presentations feature 460, and a refinement affordance 470. For example, following a user interacting with the trigger 430, the provider institution computing system 102 via the machine learning circuit 210 and the generative AI circuit 220 may produce information including, but not limited to, a long-form job posting for potential publication, applicable candidates sorted or ranked from a candidate pool, and other analytics with respect to the current draft of the long-form job posting as well as suggestions on refining or altering the job posting to narrow or expand the candidate pool. The rendered content may be displayed according to one or more presentation templates 168. Further, the machine learning model 210 may revise or edit presentation templates 168 based on successful past job requisitions, current trends based on market analysis, and the like. The generative AI circuit 220 may update or create additional presentation templates 168 such that the rendered content varies to match or adjust to the candidate pool for a specific application or based on the number of applicants in a specific applicant pool. Further, the generative AI circuit 220 can generate, by the second artificial intelligence model, the second object (e.g., the job posting) during a first time period. In particular, second object is a text object or multimedia object that includes text, images, or multimedia content that is descriptive of a role, and includes one or more discrete criteria associated with the role. The second object thus includes information at a greater level of detail than the first object, in a more formalized format (e.g., copy-edited) than the first object, or a combination thereof. Additionally, the provider institution computing system 102 can identify, by the first artificial intelligence model (e.g., the machine learning model 210), the one or more third objects during a second time period concurrent with the first time period. In particular, the third objects each are software objects, data structures, or data records that define or describe target candidates and scores matching the target job posting or the like. In this way, the AI circuits 130 may simultaneously analyze both the job posting and corresponding applicant pool to populate a user interface with data representative of best fit candidates or desirable job descriptions to be published for applicant review.

The candidate description feature 404B can include a long-form job posting, a formal employment description, a formal job requisition, a current draft of a target job posting, a listing of requirements and qualifications, among other qualitative and quantitative data regarding the target employment position and applicable candidates.

The candidate profile content feature 440 can include a preview, sample, or current version of the target job posting. The candidate profile content 440 may be generated by the generative AI circuit 220 based on one or more metrics developed or determined from the machine learning circuit 210 based on input from a user or data in the system memory 160. The candidate profile content 440 can include a natural language object 442, discrete candidate metrics 444, and quantitative candidate metrics 446.

The natural language object 442 can include text, graphics, lists, grammatically correct paragraphs, detailed explanations of employee benefits/pre-requisites, and the like. For example, the natural language object 442 may include a formal description for the entry level content creator position described above. The description may be written in a tone that corresponds to a designated workplace culture, may be formatted based on presentation templates 168, and the like. The natural language object may include employment requirements, salary indicators, education status, or licensure requirements, etc. The natural language object 442 may be generated by the generative AI circuit 220 based on one or more metrics (e.g., descriptive metrics, target metrics, pool parameters) generated by the machine learning circuit 210. The natural language object 442 may be displayed to a user on a first portion of the I/O devices 170.

The discrete candidate metrics 444 can include analytical data descriptive of the candidate pool and be indicative of overlap between the natural language object 442 and the candidate pool. The discrete candidate metrics 444 may be generated by the machine learning circuit 210 and displayed in the candidate description 404B in a format, presentation, or template generated by the generative AI circuit 220. The discrete candidate metrics 444 may include measurable attributes or characteristics based on the machine learning circuit's evaluation of the candidate pool and qualifying candidates. For example, the discrete candidate metrics may include years of experience in an industry (e.g., a range of years, a minimum number of years, etc.), educational qualifications (degree level, degree type and subject, CLE qualifications, etc.), technical skill proficiencies (e.g., licensures, technical certifications, accolades, awards, etc.) language proficiencies, and other suitable characteristics and qualifications. The discrete candidate metrics 444 may be determined based on weighted importance of certain qualifications as predicted or designated by the machine learning circuit 210 via the target metric processor 214, target metrics, etc. For example, the provider institution computing system 102 may determine that years of experience is of particular importance given the detail provided in the candidate outline content 410 based on the hiring practices or historical data observed or found in the system memory 160. Additionally, the discrete candidate metrics 444 may be designated based on user interaction, such as qualifications or characteristics that correspond to selected affordances 422.

The quantitative candidate metrics 446 can include an analysis of the candidate pool and the applicability of the discrete candidate 442 metrics to the candidate pool. For example, the quantitative metrics 446 may include a percentage of the candidate pool that has two to five years of experience, a ranking of the most common qualification shared amongst the candidate pool, or other suitable insights determined from the machine learning model 210 and provided to the generative AI model 220.

The annotation object 450 can include internal data for the user/recruiter to review that does not fall within the formal job posting, job requisition, or candidate profile content 440. For example, the annotation object 450 may be generated by the machine learning circuit 210 to assist the user/recruiter in refining or optimizing the candidate pool. Accordingly, the annotation object 450 may include suggested metrics or qualifications to provide to the generative AI model to reform, revise, or adjust the candidate profile content 440 and/or the candidate pool. For example, the annotation object may include insights such as “narrowing the location to New York will increase qualified candidate pool by 35%,” “remove two-to-five-year experience requirement or adjust to one-to-five-year experience requirement to increase qualified candidate pool by 30 candidates.” Additionally, the annotation object may indicate a number of candidates viewed, a number of candidates excluded, graphical depictions indicating a degree of overlap between the qualification and the candidate pool, or other analytical insights provided by the machine learning circuit 210 and generated by the generative AI circuit 220.

The provider institution computing system 102 can obtain, by a communication interface from the third-party system 104, the one or more third objects (e.g., candidate profiles). The third-party system 104 may be configured to obtain the one or more third objects by one or more second user interfaces configured to receive one or more second metrics corresponding to the first metrics. In particular, the second metrics are data or metadata that are indicative of candidate characteristics that satisfy at least a predetermined number or percentage of criteria indicated in a second object. The third objects may be displayed in a pool presentation 406B, which may include a listing, ranking, chart, or other depiction of the one or more third objects. For example, the pool presentation 406B may include candidate presentations 462, candidate profile objects 462, and candidate assessment metrics 464.

The candidate presentations feature 460 refers to a listing or representation of qualified candidates that overlap with the candidate profile content 440 (e.g., the current long-form job posting). In this way, the candidate presentations feature 460 may inform the user/recruiter in real time of which candidates are suited to the job posting in its current form and the degree of overlap or fit those candidates have with the candidate description 404B. The candidate presentations feature 460 can include a candidate profile object 462, and a candidate assessment metric 464.

The candidate profile object 462 is a graphic, visual, or other representation of a specific candidate from the candidate pool. The candidate profile object may include a name, photograph, resume, biographical snippet or summary, representative qualifications, shared qualifications between the qualified candidate and the candidate description 404B or the like. For example, the candidate profile object 462 may detail the years of experience of a candidate. Further, the machine learning circuit 210 may generate an explanation indicating the reason for the candidate's matching with the respective job posting, which may be formatted, generated, and presented by the generative AI circuit 220.

The candidate assessment metric 464 is a numeral, ranking, percentage, or other indication of the match between the candidate and the candidate description 404B as determined by the machine learning circuit 210. For example, the candidate assessment metric 464 may include a ranking, a percentage value based on a comparison of the candidate data and one or more metrics generated from the candidate outline content 410, and the like. The candidate assessment metric 464 may also include a graphical indication or a listing of traits, qualities, or characteristics that the candidate shares with the current long-form job posting. Further, the candidate assessment metric 464 may be interactive and configured to display additional data in response to input from a user interface. For example, hovering a cursor over the candidate assessment metric 464 may prompt the machine learning circuit 210 to determine adjustments to the job posting that may increase the match or fit between the candidate and the candidate description 404B. In this way, the machine learning circuit 210 may interact simultaneously with the generative AI circuit 220 to both vary parameters and metrics regarding the candidates that the job posting is directed to as well as requirements and properties of the job posting itself. The machine learning circuit 210, for example, may generate data indicating that a candidate's prior employment history would further apply if certain responsibilities (e.g., managing personnel) were added to the job posting and/or generate data indicating that the location (e.g., within 10 miles of Boston) lowers the applicability of the posting to the candidate.

The refinement affordance 470 is an input feature structured or configured to allow a user/recruiter to narrow or adjust the pool presentation 406B and/or the listing of qualified applicants based on additional features or traits. For example, the activating or accessing the refinement affordance may prompt a user to input additional data to narrow or refine the candidate pool. The refinement affordance 470 may prompt the machine learning circuit 210 to generate additional or present one or more unselected affordances 420 or prompt additional information to be received via a user interface into the candidate outline content 410. Further, the refinement affordance 470 may generate or cause a UI to present a refinement user interface.

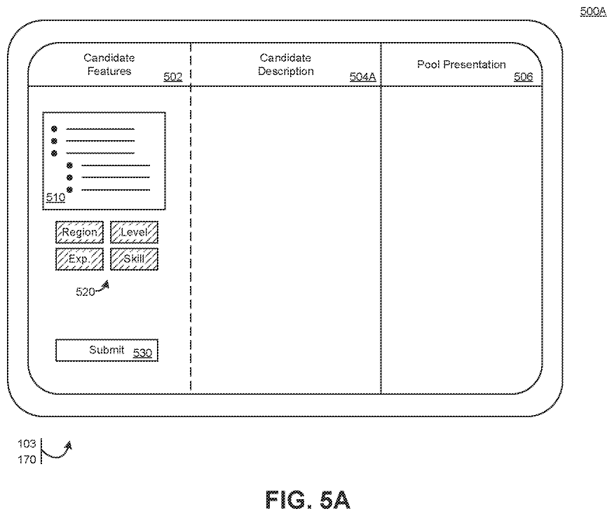

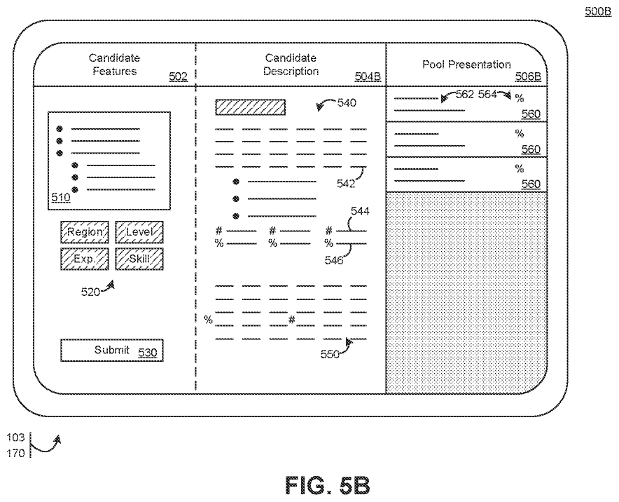

FIG. 5A depicts an example refinement user interface, according to some embodiments. As illustrated by way of example in FIG. 5A, a refinement user interface or refinement graphical user 500A can include at least a candidate features presentation feature 502, a candidate description presentation feature 504A, and a pool presentation feature 506A. The refinement user interface 500A may be created by the generative AI circuit 220 in response to prompts provided by the machine learning circuit 210. The prompts, in turn, may be suggested or determined by the machine learning circuit 210 and in part based on input received via a user interface selecting one or more refinement affordances 470. The refinement user interface may display tags, filters, and the like configured to narrow or broaden the applicant pool. For example, for a job posting for an executive position with extensive qualifications, the initial applicant pool may only populate with two candidates at low fit scores or low percentage of overlap. The machine learning circuit 210 may determine based on one or more target characteristics 166 that the candidate pool may be broadened and overlap increased by adding additional filters. The additional filters, qualifications, and the like may be sourced in part from previous applicants, applications, and/or analysis of current market trends performed by the machine learning circuit 210. Accordingly, the refinement user interface may be pre-populated with suggested search queries or job posting alterations and indicate a respective effect the filter will cause on the target applicant pool. For example, the machine learning circuit 210 may recognize that a large number of omitted applicants are only 1-2 years of experience shy of an experience requirement. The machine learning model 210 may generate a prompt and create, via the generative AI circuit 220 a suggested filter and updated candidate pool based on an experience requirement reduced by 1-2 years.

The candidate features presentation 502 can include previous, modified, or additional inputs from a user/recruiter (e.g., via the I/O devices 170) indicative of job preferences, candidate requirements, employee responsibilities, and other target features or aspects to include in the job posting in view of the previously generated candidate pool or pool presentation 406A. The candidate features presentation 502 can include a modified candidate outline content feature 510, a modified affordances feature 520, and a submission affordance feature 530. For example, the provider institution computing system 102 can determine, by the first artificial intelligence circuit (e.g., the machine learning circuit 210) according to a characteristic indicating a target value regarding a set of the one or more third objects, a second metric such as a tag likely to narrow the applicant pool, a feature unsatisfied by any applicant to be removed or revised, and/or a job qualification that may include applicants excluded that would otherwise highly fit the target position. The second metric may include target values, properties, or employment qualifications that optimize the job posting for the candidate pool or optimize the candidate pool for the job posting. For example, in this context, an optimized job posting is a job posting including content that, when provided to a machine learning model as discussed herein, returns a candidate pool having a number of candidates within a predetermined range, where a predetermined minimum number or percentage of candidates in the applicant pool have candidate assessment metrics that meet a minimum match threshold. For example, the predetermined range is between 10 and 30 candidates, and the minimum match threshold is a 65% match to the job posting. Specifically, the first artificial intelligence circuit may determine the second metric according to a characteristic—the characteristic indicating a target value of the property of the entity (e.g., defining an experience level of 7 or more years will narrow the applicant pool to ten high-scoring applicants) or indicating a target value regarding a set of the one or more third objects (e.g., toggling to remote-work friendly will expand the applicant pool from zero applicants to 5 applicants).

The modified candidate outline content 510 is a feature representation depicting revised input data from a user/recruiter aimed at providing additional requirements or narrowing/refining the candidate pool. For example, the modified candidate outline 510 may include prompts or suggestions of refining features provided by the machine learning circuit 210. Specifically, the modified candidate outline 510 may include an additional text string indicating a region limitation on the job posting (e.g., hiring in New York).

The modified affordances 520 can include additional refining features to narrow or adjust the pool presentation 406B and/or the listing of qualified applicants based on additional features or traits. For example, a user may select modified affordances 520 such as filters, tags, new limitations, optional qualifications, and the like. As shown in FIG. 5A, the modified affordances 520 include filters for a region (e.g., a region where the candidates are located, a region where the employer is located, etc.) and an experience filter (e.g., a certification requirement, a designated minimum number of years of experience, or the like).

The submission affordance 530 can prompt the provider institution computing system 102 to apply the additional features, modified affordances 520, and/or modified candidate outline 510 to generate an update job posting and/or candidate pool. For example, the machine learning model 210 may apply a second metric when analyzing the candidate pool and remove or add candidates corresponding to the second metric. The candidate description presentation 504A and the pool presentation 506A can refresh, remain the same and show the previously generated job requisition and candidate pool, or change in real time to reflect each modification/addition/removal of one or more metrics or affordances.

FIG. 5B depicts an example refinement user interface including rendered content, according to some embodiments. As illustrated by way of example in FIG. 5B, a refinement user interface or graphical user interface includes a rendered content feature 500B that includes at least a candidate description presentation feature 504B and a modified candidate profile content feature 540. The refinement user interface including rendered content may represent a filtered or narrowly tailored job posting including further details and distinguishing features of the candidates. The machine learning model 210 and generative AI model 220 may generate additional metrics, statistics, and/or data objects indicative of features shared by the applicants, further characteristics of the applicants that correlate with the target job posting, or illustrations/explanations of drawbacks apparent from an applicant's profile that result in a lowered score of the applicant compared to other applicants in the narrowed pool.

The candidate description presentation 504B is a depiction of an updated and/or revised long-form job posting, a formal employment description, a formal job requisition, a current draft of a target job posting, a listing of requirements and qualifications, among other qualitative and quantitative data regarding the target employment position and applicable candidates in light of the revisions and changes submitted by the user and processed by the machine learning circuit 210 and the generative AI circuit 220. For example, the provider institution computing system 102 can generate, by the second artificial intelligence model (e.g., the generative AI circuit 220) receiving as input one or more of the first metrics (e.g., requirements for the posting, employer preferences, insights generated by the machine learning circuit 210) and a second metric corresponding to a property of the entity (e.g., a target parameter of the job posting to be optimized, a refinement affordance 470 generated or suggested by the machine learning circuit 210, etc.), a fourth object which can include third text descriptive of the property of the entity and the second metric (e.g., an updated or refined job posting created by the generative AI circuit 220 in view of the refinement affordance 470). To perform this refinement, the provider institution computing system 102 may make inferential steps to optimize the job requirements in order to improve or narrow down the candidate pool. For example, the provider institution computing system 102 can identify, by the first artificial intelligence circuit (e.g., the machine learning circuit 210) and based on one or more of the first metrics (e.g., pool metrics 164, entity metrics 162), a feature indicative of the property of the entity (e.g., a predicted aspect of an applicant or job description that will improve the accuracy of the candidate pool based on one or more replacements applied to current or historical candidate data). The feature indicative of the property of the entity may include suggestions or alterations generated by the machine learning circuit 210 after analyzing the initial job posting created by the generative AI circuit 220. Some exemplary features may include projected salaries for a role and estimations on how adjusting the salary range will impact candidate acceptance rate, estimated compensation range for a target potential candidate given their experience level, as generated by the machine learning circuit 210, or the like.

The modified candidate profile content 540 can is a representation depicting a modified preview, sample, or current version of the target job posting in view of the additional criteria submitted by the user or prompted by the provider institution computing system 102 (e.g., via the modified affordances 520). The modified candidate profile content 540 may be generated by the generative AI circuit 220 based on one or more metrics developed or determined from the machine learning circuit 210 based on input from a user or data in the system memory 160. Additionally, the machine learning circuit 210 may utilize the first metrics to identify a feature indicative of a property of the job posting or candidate pool (e.g., an education requirement adjustment, a salary range estimation to increase or decrease the candidate pool). The machine learning circuit 210 may then utilize the feature in combination with a characteristic indicating a target value regarding the candidate pool and/or a characteristic indicating a target value of the property (e.g., a designated type of degree, a target salary, etc.). The characteristics may be generated, stored, or received from the target characteristics 166 in the system memory 160. The machine learning circuit 210 May determine a second metric (e.g., based on the modified affordances, the modified candidate outline content 510, etc.) and analyze the candidate pool to find qualified candidates in light of the updated or revised job posting/candidate criteria. The generative AI circuit 220 may receive a prompt indicative of the results from the machine learning circuit 210 of a revised search of the candidate pool and generate the modified candidate profile content 540. The modified candidate profile content 540 can include a modified natural language object 542, modified discrete candidate metrics 544, and modified quantitative candidate metrics 546.

The modified natural language object 542 represent one or more images. The one or more images may represent revised (e.g., new, updated, modified, etc.) text, graphics, lists, grammatically correct paragraphs, detailed explanations of employee benefits/pre-requisites, and the like. For example, the modified natural language object 542 may include an updated formal description for the entry level content creator position described above with the addition of a region of employment (e.g., “This position is open to applicants in the city of Albany, New York”) requirement or modified experience level requirements. The description may be written in an adjusted tone or the previous tone that corresponds to a designated workplace culture, may be formatted based on the same or a modified presentation template 168, and the like. The modified natural language object 542 may include narrowed, refined, or additional employment requirements, salary indicators, education status, or licensure requirements, etc. The modified natural language object 542 may be generated by the generative AI circuit 220 based on one or more metrics (e.g., descriptive metrics, target metrics, pool parameters) generated by the machine learning circuit 210. The modified natural language object 542 may be displayed to a user on a first portion of the I/O devices 170.

The modified discrete candidate metrics 544 can include analytical data descriptive of the candidate pool and be indicative of overlap between the modified natural language object 542 and the candidate pool. The modified discrete candidate metrics 544 may be generated by the machine learning circuit 210 and displayed in the candidate description 504B in a format, presentation, or template generated by the generative AI circuit 220 that may be the same or different from the previous form of the candidate description 404B. The modified discrete candidate metrics 444 may include measurable attributes or characteristics based on the machine learning circuit's evaluation of the candidate pool and qualifying candidates refined to account for the refinements provided by the system and/or the user. For example, the modified discrete candidate metrics adjust to focus on the greatest discrepancies between the candidates. For example, the modified discrete candidate metrics may indicate that only one candidate has two or more technical certifications. The modified discrete candidate metrics 544 may also similarly include years of experience in an industry (e.g., a range of years, a minimum number of years, etc.), educational qualifications (degree level, degree type and subject, CLE qualifications, etc.), technical skill proficiencies (e.g., licensures, technical certifications, accolades, awards, etc.) language proficiencies, and other suitable characteristics and qualifications. The modified discrete candidate metrics 544 may be similar to and reflect the other characteristics of the discrete candidate metrics 444.

The modified quantitative candidate metrics 546 can include an updated analysis of the candidate pool and the applicability of the modified discrete candidate metrics 542 to the candidate pool. For example, the modified quantitative candidate metrics 546 may include a percentage of the candidate pool that reflects an updated experience requirement, a ranking of the most common qualification shared amongst the candidate pool, or other suitable insights determined from the machine learning model 210 and provided to the generative AI model 220. Further, the modified quantitative candidate metrics 546 may be in the same or a different format than the quantitative candidate metrics 446. For example, the quantitative candidate metrics 446 may be in the form of a percentage, while the modified quantitative candidate metrics 546 may be in the form of a list ranking the qualified candidates in order from most to least overlap (e.g., Candidate A-Rank 1 in Experience-10 years, Candidate B-Rank 2 in Experience-7 years, etc.).

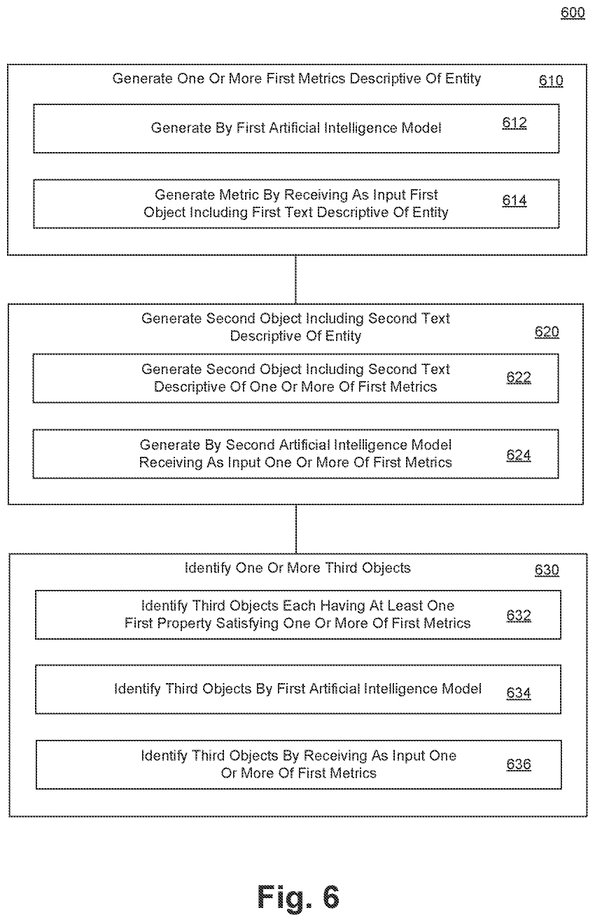

FIG. 6 depicts an example method for providing a real-time applicant dashboard and tool, according to some embodiments. Various components and/or systems of the provider institution computing system 102 can perform the method 600. Via the method 600, the provider institution computing system 102 may allow the provider institution computing system 102 to receive informal text descriptions, bullet point lists, and other data (e.g., example resumes, job titles, salary ranges) and generate a job posting and corresponding candidate pool via data-driven insights and feedback communication between the AI circuits 130 over the inter-circuit interface 310. Via the method 600, the provider institution computing system 102 may also provide suggested revisions, insights, and refinements and the corresponding effects that the refinements will provide to the applicant pool and/or job posting.

At 610, one or more first metrics descriptive of the entity is generated. In particular, the target metric processor 214 can generate one or more first metrics descriptive of the entity. The entity, in this example, is a candidate for a position described by or identified by a job posting. The first metrics may include entity metrics 162 and/or pool metrics 164 drawn from data previously analyzed by the machine learning model 210 or determined as relevant by the machine learning model 210 applying a target characteristic 166 in light of input received via a user interface.

At 612, a first artificial intelligence model generates the one or more first metrics descriptive of the entity. The first artificial intelligence model, in this example, is the model processor 218 of the machine learning circuit 210. For example, the first artificial intelligence model (e.g., the machine learning circuit 210) may generate descriptive metrics, target metrics, and the like to be communicated as one or more prompts to the generative AI circuit 220 via the inter-model interface.

Specifically, at 614, the first artificial intelligence model generates the one or more metrics by receiving as input a first object including first text descriptive of an entity. For example, a first object can correspond to data including the candidate outline content 410 such as informal job preferences and descriptions received via a user interface.

At 620, a second object including second text descriptive of the entity is generated. In particular, the model processor 226 of the generative AI circuit 220 can generate a second object including second text descriptive of the entity. The second object, in this example, is a job posting. The second text, in this example, is an optimized job posting. For example, the second object may include initial candidate profile content 440 based on inputs received via user interfaces and profile content determined applicable by the machine learning model 210 after applying one or more characteristics to applicant pool data. At 622, a second object including second text descriptive of one or more of the first metrics is generated. In particular, the model processor 226 of the generative AI circuit 220 can generate a second object including second text descriptive of one or more of the first metrics. Specifically, at 624, the second object including second text descriptive of one or more of the first metrics by a second artificial intelligence model receiving as input one or more of the first metrics is generated. In particular, the model processor 226 of the generative AI circuit 220 can generate the second object including second text descriptive of one or more of the first metrics by a second artificial intelligence model receiving as input one or more of the first metrics. At this step, the machine learning model provides a prompt predicted to generate a tailored job description based on insights gained from the user input (employer informal description) and other data analyzed by the machine learning model 210. The generative AI circuit 220 then processes the prompt to generate a corresponding job posting (e.g., utilizing presentation templates 168 and the presentation circuit 150) for initial display and refinement. The second object may include, for example, a first draft of a job posting based on data initially received via the user interface and without considering additional refinements generated by the inter-model interface.

At 630, one or more third objects (e.g., candidates in the candidate pool having one or more characteristics overlapping with the first metrics) is identified. In particular, the model processor 218 of the machine learning circuit 210 can identify one or more third objects. Specifically, at 632, the third objects (e.g., target candidates) are identified, each having at least one first property satisfying one or more of the first metrics (e.g., an experience level overlapping with likely experience necessary for the job posting as deduced from the machine learning model 210 based on inputs received such as the informal candidate outline content 410). At 634, the third objects are identified by the first artificial intelligence model, and may perform this identification, at 636, by receiving as input one or more of the first metrics via the inter-model interface from the machine learning model 210. In this way, the informal input received via the user interface is refined into tailored prompts and descriptors pulled from past applicants and postings (e.g., those that had a high success rate) and utilized to predict a number of candidates from the candidate pool that are likely to satisfy the employer's desired qualifications.

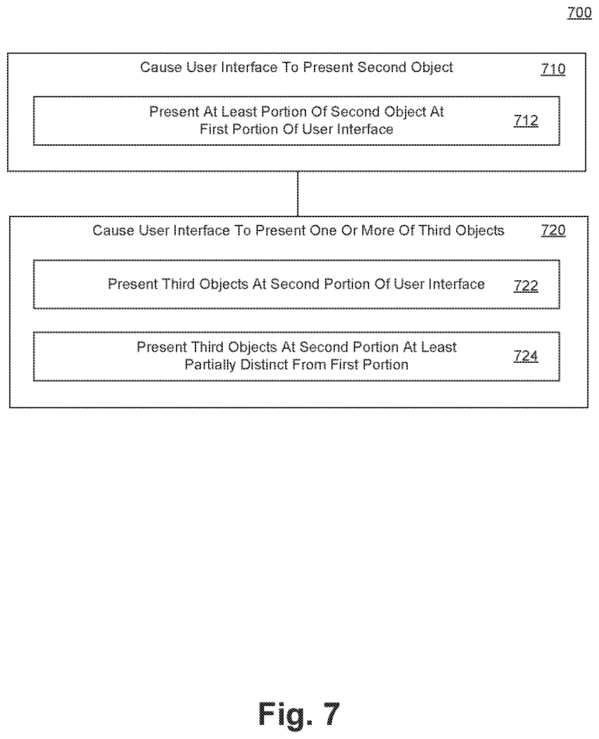

FIG. 7 depicts exemplary additional steps to the method for providing a real-time applicant dashboard and tool of FIG. 6, according to some embodiments. Various components and/or systems of the provider institution computing system 102 can perform the method 700. At 710, a user interface is caused to present the second object. In particular, the presentation circuit 320 can cause a user interface to present the second object. For example, the generative AI model 220 may create a job description with multiple components such as a natural language object 442 descriptive of attributes of the job posting or required in a candidate. At 712, at least a portion of the second object is presented at a first portion of the user interface. In particular, the presentation circuit 320 can cause a user interface to present at least a portion of the second object is presented at a first portion of the user interface. In this way, the job posting may be displayed on the user interface at a location and in a manner that highlights the most relevant portions, as determined by the machine learning model 210. Not only can the provider institution computing system 102 generate a job posting, the provider institution computing system 102 also detects attributes or characteristics for refinement which are most likely to result in narrowed or highly qualified candidates and display these values adjacent to the job description. An example of this inferential step may include displaying the annotation object 450 below the candidate profile content 440 in order to suggest alterations and changes to the job posting and their corresponding effects on the candidate pool.

At 720, the user interface is caused to present one or more of the third objects. In particular, the presentation circuit 320 can cause a user interface to present one or more of the third objects. For example, the third objects may include refined or narrowed candidate profiles based on one or more refinement affordances 470 or the like. At 722, the third objects are presented at a second portion of the user interface and specifically, at 724, the third objects are presented at the second portion at least partially distinct from the first portion. At this step, for example, the refined candidate pool may be displayed at a user interface in line with or adjacent to the updated candidate profile to illustrate the effect of the refinement on the candidate pool and job posting.

For example, the method can include generating, by the second artificial intelligence model receiving as input one or more of the first metrics and a second metric corresponding to a property of the entity, a fourth object can include third text descriptive of the property of the entity and the second metric. For example, the computer readable medium can include one or more instructions executable by a processor. The processor can generate, by the second artificial intelligence model receiving as input one or more of the first metrics and a second metric corresponding to a property of the entity, a fourth object which can include third text descriptive of the property of the entity and the second metric.

For example, the method can include identifying, by the first artificial intelligence circuit and based on one or more of the first metrics, a feature indicative of the property of the entity. For example, the computer readable medium can include one or more instructions executable by a processor. The processor can identify, by the first artificial intelligence circuit and based on one or more of the first metrics, a feature indicative of the property of the entity.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A system, comprising:
a memory;
one or more processors coupled to the memory, the one or more processors configured to:
generate, by a first artificial intelligence model receiving as an input a first object including a first textual description of an entity, one or more first metrics descriptive of the entity;
generate, by a second artificial intelligence model receiving as an input one or more of the first metrics, a second object including a second textual description of the entity and one or more of the first metrics;
identify, by the first artificial intelligence model receiving as an input one or more of the first metrics, one or more third objects each having at least one first property satisfying one or more of the first metrics;
cause a user interface to present at least a portion of the second object at a first portion of the user interface; and
cause the user interface to present at least a portion of one or more of the third objects at a second portion of the user interface at least partially distinct from the first portion of the user interface.

2. The system of claim 1, wherein the one or more processors are further configured to:
generate, by the second artificial intelligence model receiving as an input one or more of the first metrics and a second metric corresponding to a property of the entity, a fourth object including a third textual description of the property of the entity and the second metric.

3. The system of claim 2, wherein the one or more processors are further configured:
identify, by the first artificial intelligence circuit and based on one or more of the first metrics, a feature indicative of the property of the entity.

4. The system of claim 2, wherein the one or more processors are further configured:
determine, by the first artificial intelligence circuit according to a characteristic indicating a target value of the property of the entity, the second metric.

5. The system of claim 2, wherein the one or more processors are further configured:
determine, by the first artificial intelligence circuit according to a characteristic indicating a target value regarding a set of the one or more third objects, the second metric.

6. The system of claim 1, wherein the first object includes text descriptive of an outline of a job posting, the second object includes text formatted according to a job posting that is descriptive of one or more criteria of the job posting, the first metrics are descriptive of a job candidate, the second metrics are descriptive of one or more job criteria associated with the job posting, and the third metrics are descriptive of one or more candidates associated with the job posting.

7. The system of claim 1, wherein the one or more processors are further configured:
generate, by the second artificial intelligence model, the second object during a first time period; and
identify, by the first artificial intelligence model, the one or more third objects during a second time period concurrent with the first time period.

8. The system of claim 1, wherein the first artificial intelligence model is trained according to a machine learning system, and the second artificial intelligence model is trained according to a generative artificial intelligence system.

9. A method, comprising:
generating, by a first artificial intelligence model receiving as an input a first object including a first textual description of an entity, one or more first metrics descriptive of the entity;
generating, by a second artificial intelligence model receiving as an input one or more of the first metrics, a second object including a second textual description of the entity and one or more of the first metrics;
identifying, by the first artificial intelligence model receiving as an input one or more of the first metrics, one or more third objects each having at least one first property satisfying one or more of the first metrics;
causing a user interface to present at least a portion of the second object at a first portion of the user interface; and
causing the user interface to present at least a portion of one or more of the third objects at a second portion of the user interface at least partially distinct from the first portion of the user interface.

10. The method of claim 9, further comprising:
generating, by the second artificial intelligence model receiving as an input one or more of the first metrics and a second metric corresponding to a property of the entity, a fourth object including a third textual description of the property of the entity and the second metric.

11. The method of claim 10, further comprising:
identifying, by the first artificial intelligence circuit and based on one or more of the first metrics, a feature indicative of the property of the entity.

12. The method of claim 10, further comprising:
determining, by the first artificial intelligence model according to a characteristic indicating a target value of the property of the entity, the second metric.

13. The method of claim 10, further comprising:
determining, by the first artificial intelligence circuit according to a characteristic indicating a target value regarding a set of the one or more third objects, the second metric.

14. The method of claim 9, wherein the first object includes text descriptive of an outline of a job posting, the second object includes text formatted according to a job posting that is descriptive of one or more criteria of the job posting, the first metrics are descriptive of a job candidate, the second metrics are descriptive of one or more job criteria associated with the job posting, and the third metrics are descriptive of one or more candidates associated with the job posting.

15. The method of claim 9, further comprising:
generating, by the second artificial intelligence model, the second object during a first time period; and
identifying, by the first artificial intelligence model, the one or more third objects during a second time period concurrent with the first time period.

16. The method of claim 9, wherein the first artificial intelligence model is trained according to a machine learning system, and the second artificial intelligence model is trained according to a generative artificial intelligence system.

17. A non-transitory computer readable medium including instructions stored thereon that, when executed by one or more processors, cause the one or more processors to perform operations comprising:
generating, via a first artificial intelligence model that receives as an input a first object including a first textual description of an entity, one or more first metrics descriptive of the entity;
generating, via a second artificial intelligence model that receives as an input one or more of the first metrics, a second object including a second textual description of the entity and one or more of the first metrics;
identifying, via the first artificial intelligence model that receives as an input one or more of the first metrics, one or more third objects each having at least one first property satisfying one or more of the first metrics;
causing a user interface to present at least a portion of the second object at a first portion of the user interface; and
causing the user interface to present at least a portion of one or more of the third objects at a second portion of the user interface at least partially distinct from the first portion of the user interface.

18. The non-transitory computer readable medium of claim 17, wherein the instructions, when executed by the one or more processors, further cause the one or more processors to perform operations comprising:
generating, by the second artificial intelligence model that receives as an input one or more of the first metrics and a second metric corresponding to a property of the entity, a fourth object including a third textual description of the property of the entity and the second metric.

19. The non-transitory computer readable medium of claim 17, wherein the instructions, when executed by the one or more processors, further cause the one or more processors to perform operations comprising:
identifying, by the first artificial intelligence model and based on one or more of the first metrics, a feature indicative of the property of the entity.

20. The non-transitory computer readable medium of claim 17, wherein the instructions, when executed by the one or more processors, further cause the one or more processors to perform operations comprising:
determining, by the first artificial intelligence model according to a characteristic, the second metric, the characteristic indicating a target value of the property of the entity or indicating a target value regarding a set of the one or more third objects.
